(19) United States
(12) Patent Application Publication
(10) Pub. No.: US 2026/0228084 A1
(43) Pub. Date: Aug. 6, 2026

(54) Rapid RAM Initialization Using ECC Dirty Flags

(71) Applicant: Silicon Laboratories Inc., Austin, TX (US)

(72) Inventor: Thomas David, Lakeway, TX (US)

(21) Appl. No.: 19/042,325

(22) Filed: Jan. 31, 2025

(51) Int. Cl. G06F 11/10

(52) U.S. Cl. CPC G06F 11/1068; G06F 11/1016

(57) ABSTRACT

A system and method for rapid initialization of an ECC protected memory is disclosed. Rather than rewriting the entire memory after each power up or return from a low power mode, the present system adds an additional ECC Dirty flag to each data word in the ECC protected memory. This ECC Dirty flag is used to signify whether the data word and its associated ECC symbol have been written since the last power up. If the data word has not been written, then the generation of an ECC error is disabled. The ECC Dirty flags are written after power up with a first value to indicate that the data word and its associated ECC symbol have not been written. When writes are performed to the data word, the ECC Dirty flag is written with a second value. This second value enables the generation of ECC errors.

### FIELD

This disclosure describes systems and methods for the initialization of an ECC protected RAM after a power up or returning from a low power mode, and more specifically using a ECC Dirty Flag to identify uninitialized memory.

### BACKGROUND

The Internet of Things (IoT) has led to an explosion in the number of network devices that are available. In some of these devices, it may be important to protect the integrity of the memory, such as by the use of an Error Correction Code (ECC). In operation, each time a memory word is written, an associated ECC symbol is computed and written with the memory word. Later, when that memory word is read, the ECC symbol is checked for correctness. If there is a discrepancy, it may be possible to use the ECC symbol to correct the error, if the error is limited to a small number of bits in the memory word. Otherwise, the ECC error is reported to the processing unit, which takes an appropriate action.

Most systems that utilize ECC include an initialization process where all of the memory devices that are protected by ECC are written to known values. This process serves to generate a valid ECC symbol for each memory word. However, in systems that include large amounts of memory, such as more than 1 Mbyte, the time and power associated with this initialization process may be excessive. Furthermore, in some of these devices, the memory may be divided into a plurality of banks, where each of these banks may remain powered on or may be powered off during various low power modes. Consequently, it is possible to remove power to some or all of the memory banks. Thus, upon returning from these low power modes, it is also necessary to perform the initialization process to write known data and ECC symbols to any memory banks that were recently powered up. Again, this is a time and power consuming process.

Another option would be to not initialize the memory after a power up or a return from a low power mode. However, in this case, if there are any software issues that cause the reading of an uninitialized memory location, an ECC error is generated, which likely causes a device reset. These software issues may include, as an example, a byte write operation, where the entire word is first read before a byte in that word is written to the new value. Guaranteeing that no such software issues exist is a complex and difficult task.

Therefore, it would be advantageous if there were a system and method that allowed for a faster and lower power ECC memory initialization process.

### SUMMARY

A system and method for rapid initialization of an ECC protected memory is disclosed. Rather than rewriting the entire memory after each power up or return from a low power mode, the present system adds an additional ECC Dirty flag to each data word in the ECC protected memory. This ECC Dirty flag is used to signify whether the data word and its associated ECC symbol have been written since the last power up or return from a low power mode. If the data word has not been written, then the generation of an ECC error is disabled. The ECC Dirty flags are written after power up with a first value to indicate that the data word and its associated ECC symbol have not been written. When writes are performed to the data word, the ECC Dirty flag is written with a second value. This second value enables the generation of ECC errors. Note that this system may reduce the power and time required to initialize an ECC protected memory by a factor of 30 or more.

According to one embodiment, a device allowing rapid initialization of an Error Correction Code (ECC) protected memory is disclosed. The device comprises a processing unit; a data memory device, organized as: a plurality of data words; an ECC symbol associated with each of the plurality of data words; and an ECC Dirty Flag associated with each of the plurality of data words; and an ECC circuit, where the ECC circuit does not indicate an ECC error for a data word if the ECC Dirty Flag associated with that data word is set to a first value, indicating that the data word and associated ECC symbol have not been written since a last power up or return from a low power mode. In some embodiments, the ECC Dirty Flag is initialized after the power up or return from the low power mode with the first value to indicate that the data word and ECC have not been written. In certain embodiments, the ECC Dirty Flag is initialized using a state machine or a Direct Memory Access (DMA) controller. In certain embodiments, the data word and associated ECC symbol are not written when the ECC Dirty Flag is initialized to the first value. In some embodiments, when the data word is written, the ECC Dirty Flag is written with a second value indicating that the data word and associated ECC symbol have been written since the last power up or return from low power mode.

According to another embodiment, a method for quickly initializing and operating an Error Correction Code (ECC) protected memory is disclosed. The method comprises associating an ECC Dirty Flag with each data word in the ECC protected memory; writing the ECC Dirty Flag to a first value that indicates that the data word and associated ECC symbol have not been written since a last power up or return from a low power mode; and writing the ECC Dirty Flag to a second value when the data word and associated ECC symbol are written; wherein an ECC error cannot be indicated for the data word if the associated ECC Dirty Flag is set to the first value. In some embodiments, the ECC Dirty Flag is written to the first value after the power up or return from the low power mode. In certain embodiments, the ECC Dirty Flag is written to the first value by a Direct Memory Access (DMA) controller or a state machine. In some embodiments, when the ECC Dirty Flag is written to the first value, the data word and associated ECC symbol are not written.

According to another embodiment, a device allowing rapid initialization of an Error Correction Code (ECC) protected memory is disclosed. The device comprises a processing unit; a data memory device, organized as one or more banks, wherein each bank comprises: a plurality of data words; and an ECC symbol associated with each of the plurality of data words; one or more ECC Dirty Flag memories, each associated with one of the one or more banks, wherein one bit in the ECC Dirty Flag memory is associated with each data word in the data memory device; and an ECC circuit, where the ECC circuit uses the data word to generate the ECC symbol on a write operation and uses the data word, the ECC symbol and the bit in the ECC Dirty Flag memory associated with the data word to generate an ECC error to the processing unit on a read operation. In some embodiments, the ECC error cannot be generated if the bit in the ECC Dirty Flag memory associated with the data word is set to a first value. In certain embodiments, the ECC circuit sets the bit in the ECC Dirty Flag memory associated with the data word to a second value whenever the data word is written. In certain embodiments, the ECC error is generated if the bit in the ECC Dirty Flag memory associated with the data word is set to the second value and the ECC symbol does not match an expected ECC symbol. In some embodiments, a number of bits in the ECC Dirty Flag memory is equal to a number of data words in the bank. In certain embodiments, the ECC Dirty Flag memory is organized as words, each word having a plurality of bits. In certain embodiments, a first portion of a memory address used to access the data word is used to determine a ECC Dirty Flag memory address and a second portion of the memory address is used to select a bit within the word located at the ECC Dirty Flag memory address. In certain embodiments, the words in the ECC Dirty Flag memory are 16, 32 or 64 bits. In certain embodiments, an ECC Dirty Flag Write state machine is configured to write all bits in each word in the ECC Dirty Flag memory to a first value after a power up. In certain embodiments, the ECC Dirty Flag Write state machine is configured to write all bits in each word in the ECC Dirty Flag memory to the first value after returning from a low power mode if the bank was powered off during the low power mode. In certain embodiments, the ECC Dirty Flag Write state machine does not write the plurality of data words and associated ECC symbols.

### BRIEF DESCRIPTION OF THE DRAWINGS

For a better understanding of the present disclosure, reference is made to the accompanying drawings, in which like elements are referenced with like numerals, and in which:

FIG. 1 shows a block diagram of a network device according to one embodiment;

FIG. 2 shows the configuration of the data memory device during a read operation;

FIG. 3 shows the configuration of the data memory device during a write operation;

FIG. 4 shows the address translation for the ECC Dirty Flag memory; and

FIG. 5 shows the circuitry used to perform the initialization process according to one embodiment.

### DETAILED DESCRIPTION

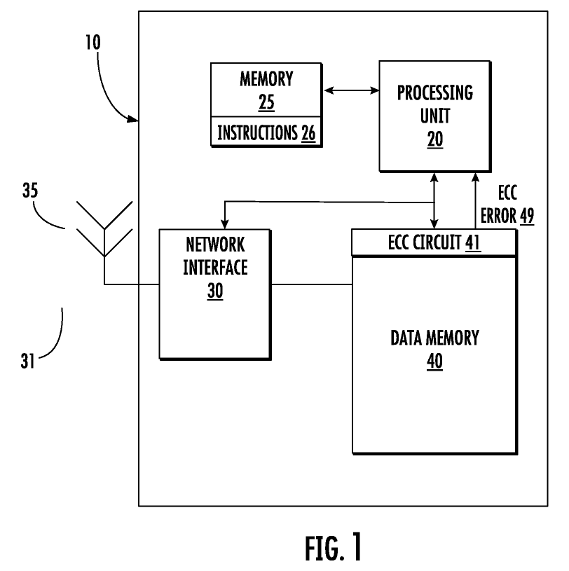

FIG. 1 shows a block diagram of a representative network device 10 that is able to initialize the ECC protected data memory quickly and efficiently.

The network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the network device 10 to perform the functions described herein. This memory device 25 may be a non-volatile memory, such as a FLASH ROM, an electrically erasable ROM or other suitable device. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the network device 10. The instructions contained on this second computer readable non-transitory media may be downloaded onto the memory device 25 to allow execution of the instructions by the network device 10.

The network device 10 also includes a network interface 30, which may be a wireless interface that connects with an antenna 35. The network interface 30 may support multiple wireless networks, such as Bluetooth, Bluetooth LE (BLE), Wi-Fi, networks utilizing the IEEE 802.15.4 specification, such as Zigbee, Thread and Wi-SUN, networks utilizing the IEEE 802.15.6 specification, sub-GHz band networks, such as LoRa, frequency-shift keying and others, and wireless smart home protocols, such as Z-Wave. Further, the network interface 30 may also support a proprietary or custom wireless network. The network interface 30 includes a transmit circuit which is used to transmit data from this network device 10 using the antenna 35. The network interface 30 also includes a receive circuit which is used to receive packets from any of the plurality of networks.

The network device 10 may include a data memory device 40 in which data that is received and transmitted by the network interface 30 is stored. This data memory device 40 is a volatile memory. The processing unit 20 has the ability to read and write the data memory device 40 so as to communicate with the other nodes in the wireless network 31. The data memory device 40 may be made up of a plurality of memory banks. For example, each memory bank may be organized as 16K x 32 (with additional bits for the ECC symbol). Each memory bank may be independently powered off, if desired, during a low power mode. Additionally, the data memory device 40 includes a ECC circuit 41 that is used to create ECC values during write operations and verify ECC values during read operations. The ECC circuit 41 may return an ECC error signal 49 to the processing unit 20 if an uncorrectable ECC error is encountered. Additionally, as explained in more detail below, the data memory device 40 also includes a ECC Dirty Flag Memory.

Although not shown, the network device 10 also has a power supply, which may be a battery or a connection to a permanent power source, such as a wall outlet.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the network device 10, not its physical configuration. Further, while FIG. 1 shows a device having a network interface 30, it is understood that the data memory device 40 and ECC circuit 41 described herein may be used with other devices that do not have a network interface.

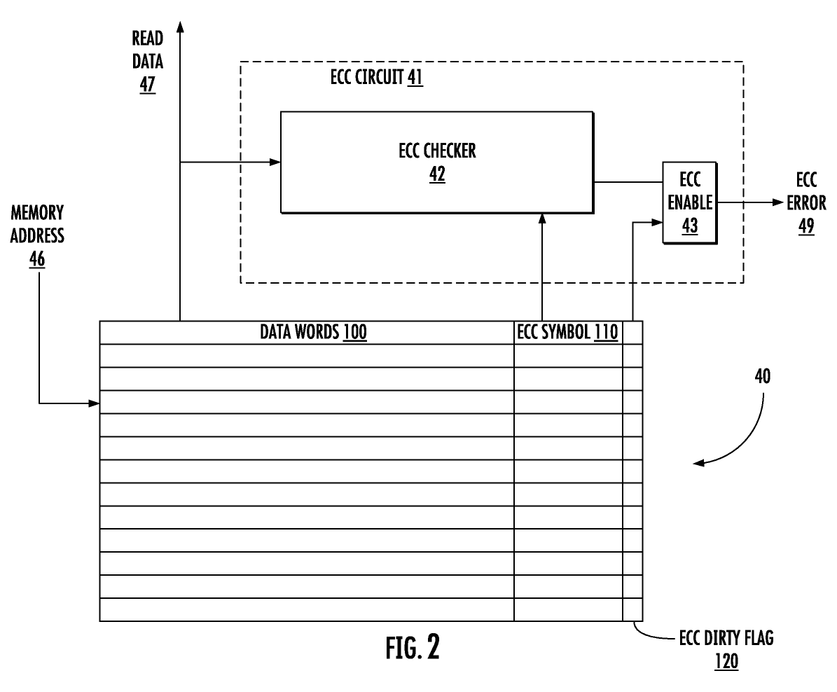

FIG. 2 shows the configuration of the data memory device 40 and ECC circuit 41 during a read operation. The data memory device 40 may be organized as a plurality of 32 bit long data words 100. Associated with each 32 bit long data word 100 is an ECC symbol 110. This ECC symbol 110 may be any suitable number of bits. For example, in some embodiments, the ECC symbol 110 may be 7 bits in length. Additionally, there is a ECC Dirty Flag 120 associated with each data word 100.

Thus, when a memory address 46 is provided to the data memory device 40, the data word 100, the ECC symbol 110 and the ECC Dirty Flag 120 are all retrieved. The data word 100 is transmitted to the processing unit 20 as read data 47. In addition, the data word 100 and the ECC symbol 110 are provided to a ECC checker 42 in the ECC circuit 41. The ECC checker 42 is a circuit that receives the data word 100 and the ECC symbol 110. In some embodiments, the ECC checker 42 computes the expected ECC symbol from the data word 100 and compares it to the ECC symbol 110 that were retrieved from the data memory device 40. If the expected ECC symbol does not match the ECC symbol 110 read from the data memory device 40, an error may be indicated. In certain embodiments, the output from the ECC checker 42 is provided as an input to an ECC Enable circuit 43. The ECC Enable circuit 43 also receives the ECC Dirty Flag 120 for this data word 100. If the ECC Dirty Flag 120 is set to a first value, indicating that the ECC is “dirty”, which denotes that the data word 100 and ECC symbol 110 have not been written since the last powerup, then the ECC Error signal 49 cannot be asserted. However, if the ECC Dirty Flag 120 is set to a second value, indicating that the ECC is not “dirty”, the ECC Enable circuit 43 passes the output from the ECC Checker 42 to the processing unit 20 as the ECC Error signal 49.

In other words, if the ECC Dirty Flag 120 is set to the first value, an ECC error signal 49 cannot be generated. Therefore, rather than having to initialize all of the memory banks, as described above, it is only necessary to initialize the ECC Dirty Flag memory.

While FIG. 2 shows the ECC Checker 42 and the ECC Enable circuit 43 as being separate components, it is understood that the functions of these two components may be integrated into a single circuit. For example, the ECC Dirty Flag 120 may be provided to the ECC checker 42 and used to disable generation of an error.

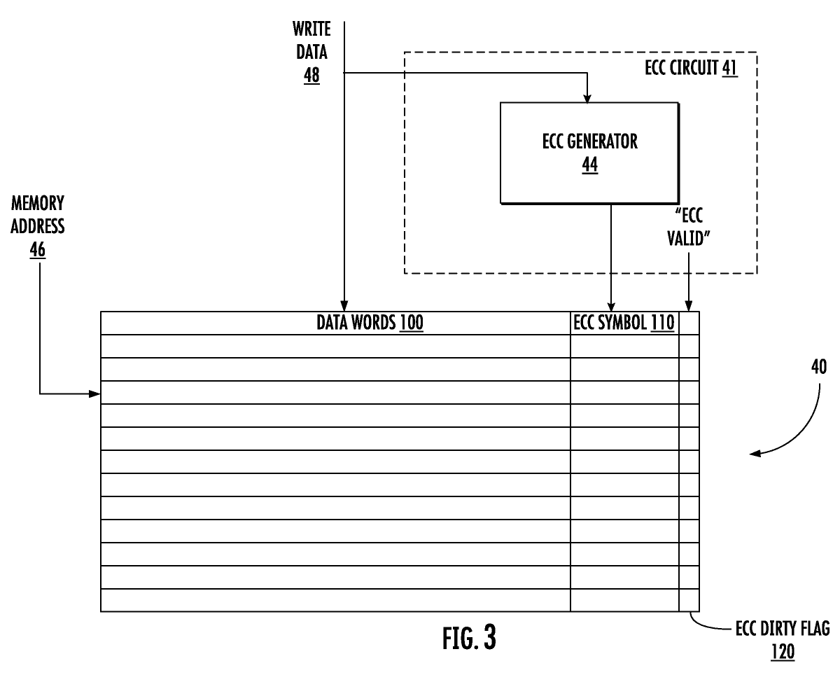

FIG. 3 shows the configuration of the data memory device 40 and ECC circuit 41 during a write operation. In this operation, write data 48 is provided to the data memory device 40. The write data 48 becomes the data word 100. Additionally, the write data 48 is provided to the ECC generator 44, which uses the write data 48 to generate an ECC symbol. The ECC generator 44 is a circuit that uses the write data 48 as an input, and generates an ECC symbol 110. This ECC generator 44 is part of the ECC circuit 41. The output from the ECC generator 44 is provided to the data memory device 40 as the ECC symbol 110. In addition, during each write operation, the ECC Dirty Flag 120 is written with the second value that indicates that the ECC symbol 110 and data word 100 have been written since the last power up or return from low power mode.

Thus, once a data word 100 is written, the ECC Dirty Flag 120 is set to the second value such that ECC errors are enabled for all subsequent reads of this data word 100.

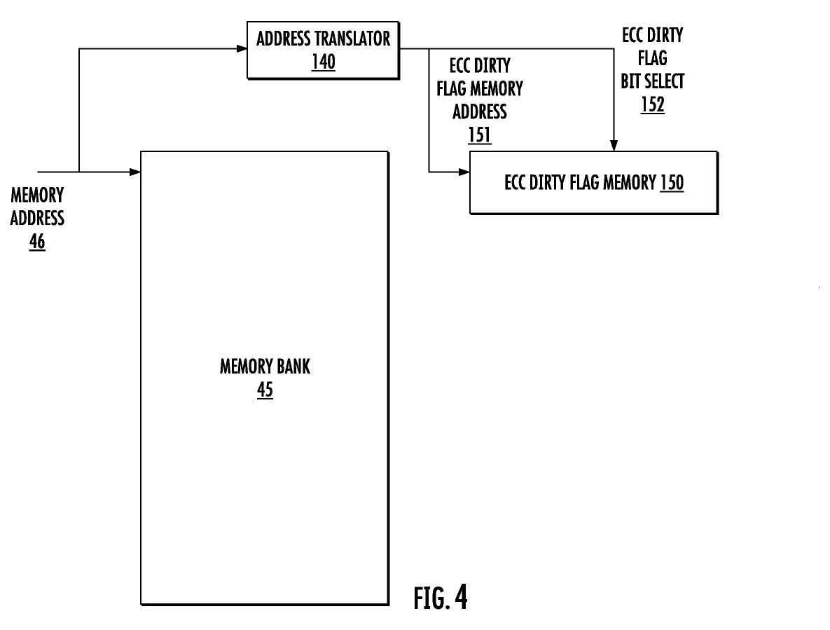

The ECC Dirty Flags 120 are arranged as separate memory elements, each of which is associated with one or more memory banks. For example, in FIG. 4, it is assumed that there is a ECC Dirty Flag Memory 150 associated with each memory bank 45. Further, there is one bit in the ECC Dirty Flag Memory 150 for each data word 100 in the memory bank 45. Thus, if there are 4096 data words in each memory bank 45, there will be an associated ECC Dirty Flag Memory 150 containing 4096 bits. These 4096 bits may be organized in any suitable manner. In some embodiments, these bits are organized as 128 rows that are each 32 bit wide. Of course, the ECC Dirty Flag memory 150 may be organized differently. For example, the ECC Dirty Flag memory 150 may be organized with more or fewer bits per word. Additionally, the memory banks 45 may be a different size. In some embodiments, the number of bits in the ECC Dirty Flag Memory is 1/32 of the number of bits in the memory bank 45 that it is associated with. Thus, if the memory bank 45 has 16K data words, the associated ECC Dirty Flag Memory 150 may contain 16K bits.

When a memory address 46 is provided to the memory bank 45, that memory address 46 is also used to index into the associated ECC Dirty Flag memory 150 to identify the bit that corresponds to the data word 100 located at that memory address 46. An address translator 140 may be used to convert the memory address 46 to an ECC Dirty Flag Memory address 151 and an ECC Dirty Flag bit select 152. Specifically, in one embodiment wherein the ECC Dirty Flag Memory 150 is organized as 32 bit entries, a first portion of the memory address 46, which includes all of the address bits in the memory address 46 except the least significant 5 bits, may be used to determine the ECC Dirty Flag Memory address 151 in the ECC Dirty Flag memory 150. A second portion, which includes the least significant 5 bits, is then used to determine the ECC Dirty Flag bit select 152, which is used to select the bit in that row that corresponds to the data word 100 located at the memory address 46. In other embodiments, a different set of bits may be used to define the first portion and the second portion. Of course, if the ECC Dirty Flag Memory 150 is organized with longer or shorter rows, the number of address bits used to identify the ECC Dirty Flag Memory address 151 and the ECC Dirty Flag Bit Select 152 may differ from that described above.

Note that in certain embodiments, there may be 1.5 Mbytes data memory, which may be organized as 96 memory banks, each memory bank 45 having a size of 4096 x 39 bits (32 bits of data word and 7 bits of ECC symbol). In this embodiment, there may be 96 ECC Dirty Flag memories 150, each having 4096 bits, which may be organized as 128 x 32 bits. Alternatively, the 96 ECC Dirty Flag memories 150 may be organized differently, such as 64 x 64 bits or 256 x 16 bits. In other words, the ECC Dirty Flag memories 150 are organized as words, each having a plurality of bits, such as 16, 32 or 64 bits. In other embodiments, there may be more or fewer memory banks. However, the relationship between the size of each memory bank 45 and the size of the associated ECC Dirty Flag memory 150 may be as defined above.

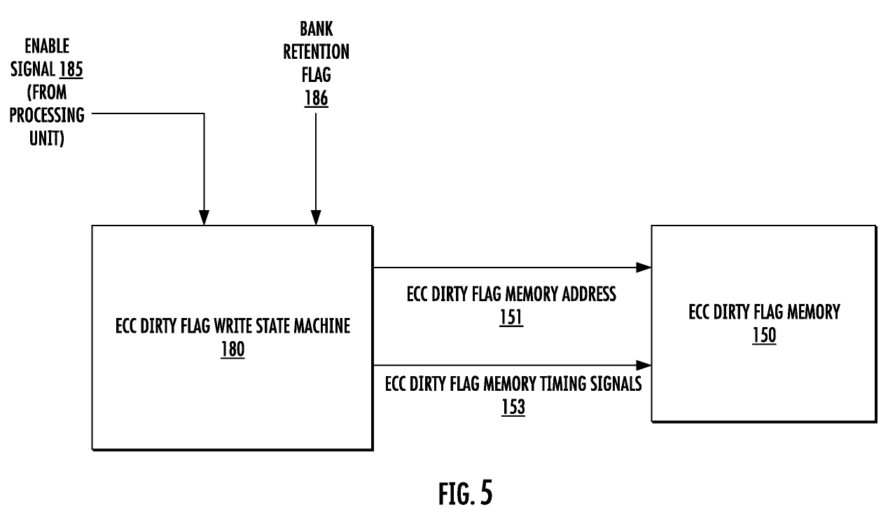

Having described the read and write operations, a description of the initialization process will be provided. As shown in FIG. 5, there is an ECC Dirty Flag Write State Machine 180 associated with each ECC Dirty Flag Memory 150. The ECC Dirty Flag Write State Machine 180 is a circuit that is configured to cycle through a plurality of ECC Dirty Flag Memory Addresses 151 and provide the necessary timing signals 153 for each ECC Dirty Flag Memory address such that each row in the ECC Dirty Flag Memory 150 is written with the first value, which is referred to as a “Dirty” flag. Further, the ECC Dirty Flag Write State Machine 180 also has several inputs. First, there may be an enable signal 185 from the processing unit 20 that informs the ECC Dirty Flag Write State Machine 180 to start the initialization process. Additionally, there may be a Bank Retention Flag 186 which defines whether the associated memory bank 45 is powered off during low power mode. If the associated memory bank is powered off (as indicated by the Bank Retention Flag 186), then the ECC Dirty Flag Write State Machine 180 will write all bits in the ECC Dirty Flag Memory 150 to the first value, to indicate that they are all “Dirty”. However, if the memory bank 45 remains powered during low power mode, then the ECC Dirty Flag Write State Machine 180 does not perform any writes to the ECC Dirty Flag memory 150, thereby preserving its original content.

Of course, the ECC Dirty Flag memory 150 may be initialized in other ways. For example, each row of the ECC Dirty Flag memory 150 may be written directly by the processing unit 20. Alternatively, the ECC Dirty Flag memory 150 may be initialized using a Direct Memory Access (DMA) controller, which copies the same data to every row of the ECC Dirty Flag memory 150. Thus, there are various means of initializing the ECC Dirty Flag memory 150.

The present system has many advantages. The disclosed system utilizes a ECC Dirty Flag memory 150 that is 1/32 the size of the data memory that is ECC protected. Consequently, the time and power consumed to initialize the ECC Dirty Flag memory 150 is roughly 3% of the time and power that is currently used to initialize the entire data memory. Furthermore, for devices that utilize a low power mode where some or all of the data memory is powered off, the time and power savings may be substantial. If a device enters low power mode every 100 milliseconds, the time required to initialize the entire data memory (assuming 1Mbyte organized as 256K words) is roughly 1.1 milliseconds. Thus, more than 1% of the awake time is consumed with initialization. In contrast, by using an ECC Dirty Flag memory, the time to initialize 256K bits in the ECC Dirty Flag memory (assuming that it is organized as 8192 x 32 bits) is only 34 microseconds. This allows more time for performing more important tasks. It also reduces power consumption accordingly.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A device allowing rapid initialization of an Error Correction Code (ECC) protected memory, comprising:
a processing unit;
a data memory device, organized as:
a plurality of data words;
an ECC symbol associated with each of the plurality of data words; and
an ECC Dirty Flag associated with each of the plurality of data words; and
an ECC circuit, where the ECC circuit does not indicate an ECC error for a data word if the ECC Dirty Flag associated with that data word is set to a first value, indicating that the data word and associated ECC symbol have not been written since a last power up or return from a low power mode.

2. The device of claim 1, wherein the ECC Dirty Flag is initialized after the power up or return from the low power mode with the first value to indicate that the data word and ECC have not been written.

3. The device of claim 2, wherein the ECC Dirty Flag is initialized using a state machine or a Direct Memory Access (DMA) controller.

4. The device of claim 2, wherein the data word and associated ECC symbol are not written when the ECC Dirty Flag is initialized to the first value.

5. The device of claim 1, wherein, when the data word is written, the ECC Dirty Flag is written with a second value indicating that the data word and associated ECC symbol have been written since the last power up or return from low power mode.

6. A method for quickly initializing and operating an Error Correction Code (ECC) protected memory, comprising:
associating an ECC Dirty Flag with each data word in the ECC protected memory;
writing the ECC Dirty Flag to a first value that indicates that the data word and associated ECC symbol have not been written since a last power up or return from a low power mode; and
writing the ECC Dirty Flag to a second value when the data word and associated ECC symbol are written;
wherein an ECC error cannot be indicated for the data word if the associated ECC Dirty Flag is set to the first value.

7. The method of claim 6, wherein the ECC Dirty Flag is written to the first value after the power up or return from the low power mode.

8. The method of claim 7, wherein the ECC Dirty Flag is written to the first value by a Direct Memory Access (DMA) controller or a state machine.

9. The method of claim 6, wherein when the ECC Dirty Flag is written to the first value, the data word and associated ECC symbol are not written.

10. A device allowing rapid initialization of an Error Correction Code (ECC) protected memory, comprising:
a processing unit;
a data memory device, organized as one or more banks, wherein each bank comprises:
a plurality of data words; and
an ECC symbol associated with each of the plurality of data words;
one or more ECC Dirty Flag memories, each associated with one of the one or more banks, wherein one bit in the ECC Dirty Flag memory is associated with each data word in the data memory device; and
an ECC circuit, where the ECC circuit uses the data word to generate the ECC symbol on a write operation and uses the data word, the ECC symbol and the bit in the ECC Dirty Flag memory associated with the data word to generate an ECC error to the processing unit on a read operation.

11. The device of claim 10, wherein the ECC error cannot be generated if the bit in the ECC Dirty Flag memory associated with the data word is set to a first value.

12. The device of claim 11, wherein the ECC circuit sets the bit in the ECC Dirty Flag memory associated with the data word to a second value whenever the data word is written.

13. The device of claim 12, wherein the ECC error is generated if the bit in the ECC Dirty Flag memory associated with the data word is set to the second value and the ECC symbol does not match an expected ECC symbol.

14. The device of claim 10, wherein a number of bits in the ECC Dirty Flag memory is equal to a number of data words in the bank.

15. The device of claim 14, wherein the ECC Dirty Flag memory is organized as words, each word having a plurality of bits.

16. The device of claim 15, wherein a first portion of a memory address used to access the data word is used to determine a ECC Dirty Flag memory address and a second portion of the memory address is used to select a bit within the word located at the ECC Dirty Flag memory address.

17. The device of claim 15, wherein the words in the ECC Dirty Flag memory are 16, 32 or 64 bits.

18. The device of claim 15, further comprising an ECC Dirty Flag Write state machine, which is configured to write all bits in each word in the ECC Dirty Flag memory to a first value after a power up.

19. The device of claim 18, wherein the ECC Dirty Flag Write state machine is configured to write all bits in each word in the ECC Dirty Flag memory to the first value after returning from a low power mode if the bank was powered off during the low power mode.

20. The device of claim 18, wherein the ECC Dirty Flag Write state machine does not write the plurality of data words and associated ECC symbols.
